(19) United States
(12) Patent Application Publication
(10) Pub. No.: US 2006/0143184 A1
(43) Pub. Date: Jun. 29, 2006

(54) Data processing apparatus and data processing method

(75) Inventors: Koichi Kobayashi, Tachikawa-shi (JP); Hiroaki Unno, Kunitachi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/254,885

(22) Filed: Oct. 21, 2005

(30) Foreign Application Priority Data
Dec. 24, 2004 (JP) 2004-375055

(51) Int. Cl. G06F 17/30

(52) U.S. Cl. 707/10

(57) ABSTRACT

A cellular phone (portable terminal) and a DVD recorder (data processing apparatus) have a BT communication function. The DVD recorder is linked to the cellular phone by radio communication within a given range to acquire identification information proper to the cellular phone. The DVD recorder sets a data-store destination corresponding to the cellular phone, based on the identification information and holds data transferred from the cellular phone in the data-store destination. Data of the cellular phone with a small memory capacity can be transferred without any troublesome linking operation, and the transferred data can be stored and managed in correspondence with the cellular phone.

### CROSS-REFERENCE TO RELATED APPLICATIONS

This application is based upon and claims the benefit of priority from prior Japanese Patent Application No. 2004-375055, filed Dec. 24, 2004, the entire contents of which are incorporated herein by reference.

### BACKGROUND OF THE INVENTION

1. Field of the Invention

The present invention relates to a data processing apparatus and a data processing method favorable for use in holding data, which is stored in a memory of, e.g., a cellular phone, in another location.

2. Description of the Related Art

In cellular phones, various applications for playing music and displaying moving pictures upon receipt of an incoming call have been used widely. Music data for an incoming call, which is called “ringing melody”, will be described as a typical example of the applications.

The system requirements for ringing melodies are cellular phones and sites dedicated to the distribution of music data thereof. A user gains access to a dedicated site from his or her cellular phone via the Internet to download desired music data therefrom. The downloaded music data is stored in a memory of the cellular phone. With an incoming-call function of the cellular phone, the music data is output from the memory and reproduced as a ringing melody when an incoming call is made.

In general, a user downloads a piece of music used as a ringing melody from a dedicated site by paying a prescribed fee for the music.

Cellular phones have drastically been improved in function. Not only the above music data of ringing melody, but also various data items such as moving picture data and game software can be downloaded from outside and used. However, the capacity of a memory build in a cellular phone is relatively small. If, therefore, a large amount of data is downloaded, the memory will be full of the data at once.

In the above case, a user has only to delete unnecessary data from the memory to secure the capacity and, in this case, the fee paid for the data becomes useless. If the user needs the deleted data at a later date, he or she has to download it from the site again, which takes time and trouble and increases costs.

In order to resolve the above problem, conventionally, a large-capacity memory device is linked to a cellular phone to store data therein. For example, Jpn. Pat. Appln. KOKAI Publication No. 2004-229165 discloses that a cellular phone and an optical disk drive (MO) are linked by a cable to transfer data from the cellular phone to the optical disk drive and store it therein, and to return the data to the cellular phone from the optical disk drive and reproduce it therefrom.

In the above Publication, however, a user has to prepare a cable and link the cellular phone and the optical disk drive by the cable each time data is transferred between them. This is very inconvenient and troublesome. The same is true of the case where the data is returned from the optical disk drive to the cellular phone.

In the above Publication, data transferred from the cellular phone is simply stored in the optical disk drive. If the optical disk drive is shared among a number of cellular phones, various data items of the cellular phones are mixed together, and data of a user can be read freely by any other person.

### BRIEF SUMMARY OF THE INVENTION

According to an embodiment of the present invention, a data processing apparatus comprises a link unit which links to a portable terminal by radio communication within a given range, an identification information acquisition unit which acquires identification information proper to the portable terminal linked by the link unit, a data-store destination setting unit which sets a data-store destination corresponding to the portable terminal, based on the identification information acquired by the identification information acquisition unit, and a holding unit which holds data transferred from the portable terminal in the data-store destination set by the data-store destination setting unit.

According to an embodiment of the present invention, a data processing apparatus comprising:

a link unit which links to a portable terminal by radio communication within a given range, an identification information acquisition unit which acquires identification information proper to the portable terminal linked by the link unit, a data-store destination setting unit which sets a data-store destination corresponding to the portable terminal, based on the identification information acquired by the identification information acquisition unit, a holding unit which holds data transferred from the portable terminal in the data-store destination set by the data-store destination setting unit, an operation sensing unit which senses a specific operation of the portable terminal, and a processing unit which performs a process related to the specific operation using the data held by the holding unit when the operation sensing unit senses the specific operation of the portable terminal.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a communication system including a DVD recorder, which serves as a data processing apparatus according to an embodiment of the present invention, and a cellular phone serving as a portable terminal communicating with the DVD recorder;

FIG. 2 is a diagram of a menu screen of a contents site in the cellular phone shown in FIG. 1;

FIG. 3 is a block diagram of a hardware configuration of the DVD recorder shown in FIG. 1;

FIG. 4 is a block diagram of a hardware configuration of the cellular phone shown in FIG. 1;

FIG. 5 is a sequence chart of a procedure for downloading contents data from a contents site by the cellular phone shown in FIG. 1;

FIG. 6 is a sequence chart of a procedure for transferring the downloaded contents data to the DVD recorder according to the embodiment of the present invention;

FIG. 7 is a diagram of a transfer setting screen of the cellular phone shown in FIG. 1;

FIG. 8 is a diagram showing a relationship between BT addresses of cellular phones and folders of the DVD recorder according to the embodiment of the present invention;

FIG. 9 is a sequence chart of a procedure for returning the contents data to the cellular phone from the DVD recorder according to the embodiment of the present invention;

FIG. 10 is a sequence chart of a procedure for notifying a user of an incoming call in silent mode using a playback function of the DVD recorder according to the embodiment of the present invention; and

FIG. 11 is a flowchart showing a procedure for editing data of the DVD recorder according to the embodiment of the present invention.

### DETAILED DESCRIPTION OF THE INVENTION

An embodiment of the present invention will be described with reference to the accompanying drawings.

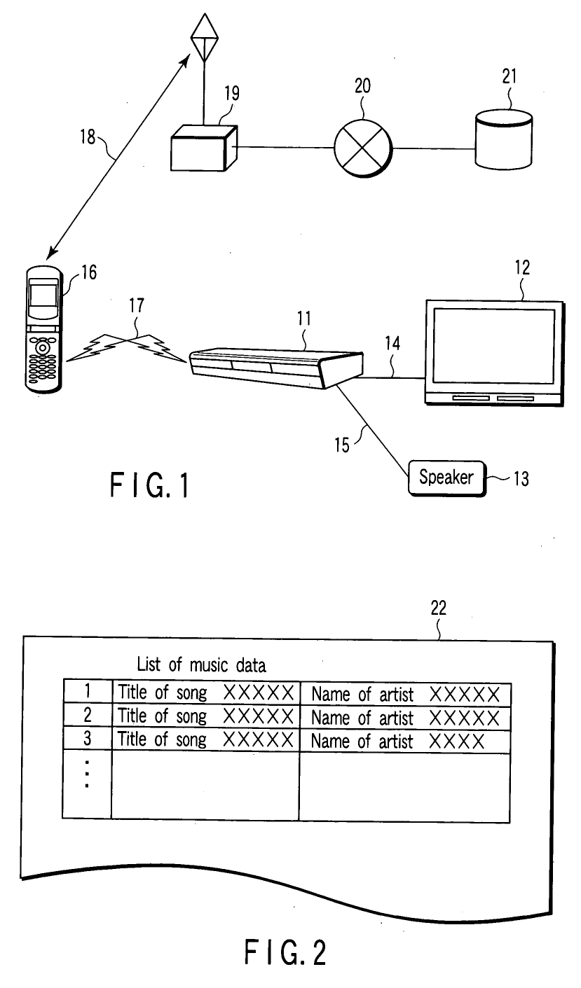

FIG. 1 is a diagram showing a communication system including a digital video disc/digital versatile disc (DVD) recorder, which serves as a data processing apparatus according to the embodiment of the present invention, and a cellular phone serving as a portable terminal that communicates with the DVD recorder.

A DVD recorder 11 is a recording/reproduction apparatus using recording-type DVDs as media. Assume here that the DVD recorder 11 is located in a user's home together with a TV monitor 12 and an audio component such as a speaker 13. The TV monitor 12 is connected to the DVD recorder 11 via a video signal cable 14 to display, e.g., video data recorded in the DVD recorder 11. The speaker 13 is connected to the DVD recorder 11 via an audio signal cable 15 to output, e.g., voice data recorded in the DVD recorder 11.

The DVD recorder 11 has a short-range radio communication function based on Bluetooth (trademark) (referred to as a BT function hereinafter). Bluetooth is a radio interface compatible with the short-range radio communication standard and allows radio communication of about 10 m using radio waves in an industrial scientific medical (ISM) band of 2.4 GHz.

A cellular phone 16 also has the BT function described above and is linked to the DVD recorder 11 so as to allow data communication therebetween through radio waves 17 in a given frequency band. The cellular phone 16 is also linked to a base station 19 through radio waves 18 to communicate with an external terminal via the base station.

A public network 20 including the Internet is linked to the base station 19, and a contents site 21 is linked to the public network 20. The contents site 21 is a dedicated one for distributing various contents such as music data and moving picture data for incoming calls. A user can gain access to the contents site 21 using the cellular phone 16 to obtain desired music data, moving picture data, or the like.

FIG. 2 is a diagram of a menu screen of the contents site 21.

When a user gain access to the contents site from the cellular phone 16, a menu screen 22 is displayed on the cellular phone 16 as shown in FIG. 2. The menu screen 22 shows a list of various items of contents data provided by the contents site 21. If the user selects desired data on the menu screen 22, the selected data is distributed from the contents site 21 and downloaded into the cellular phone 16.

In FIG. 2, a list of music data items is displayed on the menu screen 22. A music data item selected from the list by the user is downloaded into the cellular phone 16 and then can be used as a “ringing melody”. When the user obtains contents data from the contents site 21, he or she has to pay a fee in accordance with the kind of the contents data by following a predetermined procedure.

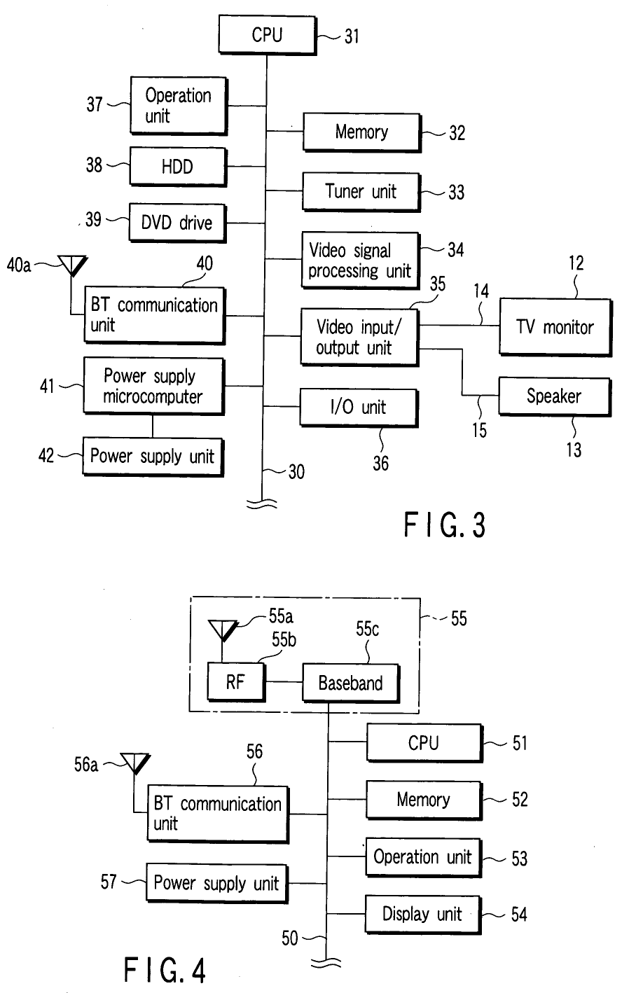

FIG. 3 is a block diagram showing a hardware configuration of the DVD recorder 11.

The DVD recorder 11 includes a CPU 31. The CPU 31 controls the DVD recorder 11 as a whole and fulfills the respective functions of the DVD recorder 11 by following the procedure described in programs. A memory 32, a tuner unit 33, a video signal processing unit 34, a video input/output unit 35, an I/O unit 36, an operation unit 37, a hard disk drive (HDD) 38, a DVD drive 39, a BT communication unit 40 and a power supply microcomputer 41 are connected to the CPU 31 via a system bus 30.

The memory 32 stores data necessary for starting up the CPU 31, such as various application programs. The application programs include an application program for fulfilling the BT function (referred to as a BT application hereinafter). Assume here that the memory 32 stores contents data of respective terminals. The capacity of the memory 32 is considerably larger than that of a memory 52 of the cellular phone 16.

The tuner unit 33 is used to receive broadcast waves from a specific broadcast station. The video signal processing unit 34 compresses video data in given format. The video input/output unit 35 inputs/outputs video data and is connected to the TV monitor 12 and the speaker 13. The I/O unit 36 is connected to a broadband network such as a local area network (LAN).

The operation unit 37 includes various buttons for operating the DVD recorder 11. The HDD 38 has a hard disk (HD) serving as a recording medium on/from which data is recorded/reproduced. For example, the HDD 38 is used to record TV video images, but it is not necessary in particular. The DVD drive 39 has a DVD as a recording medium on/from which various data items are recorded/reproduced.

The BT communication unit 40 performs radio communication using the BT function and has an antenna 40a for radio communication. The power supply microcomputer 41 supplies power to the respective circuits. The power supply unit 42 supplies power necessary for driving the DVD recorder 11.

FIG. 4 is a block diagram showing a hardware configuration of the cellular phone 16.

The cellular phone 16 includes a CPU 51. The CPU 51 controls the cellular phone 16 as a whole and fulfills the respective functions of the cellular phone 16 by following the procedure described in the programs. A memory 52, an operation unit 53, a display unit 54, a radio communication unit 55, a BT communication unit 56 and a power supply unit 57 are connected to the CPU 51 through a system bus 50.

The memory 52 stores data necessary for starting up the CPU 51, such as various application programs. The application programs include a BT application for radio communication with the DVD recorder 11.

The operation unit 53 includes various buttons for operating the cellular phone 16. The display unit 54 includes a liquid crystal display (LCD) to display a menu screen and the like.

The radio communication unit 55 performs radio communication with the base station 19 and includes an antenna 55a, a radio-frequency (RF) unit 55b and a baseband unit 55c. The BT communication unit 56 performs radio communication using the BT function and has an antenna 56a for radio communication. The power supply unit 57 supplies power necessary for driving the cellular phone 16. A rechargeable battery is used as the power supply unit 57.

An operation of the foregoing communication system will be described. The following processes shown in the sequence charts are carried out by reading given programs in microcomputers (CPU) of the contents site 21, cellular phone 16 and DVD recorder 11.

(Method of Managing Contents)

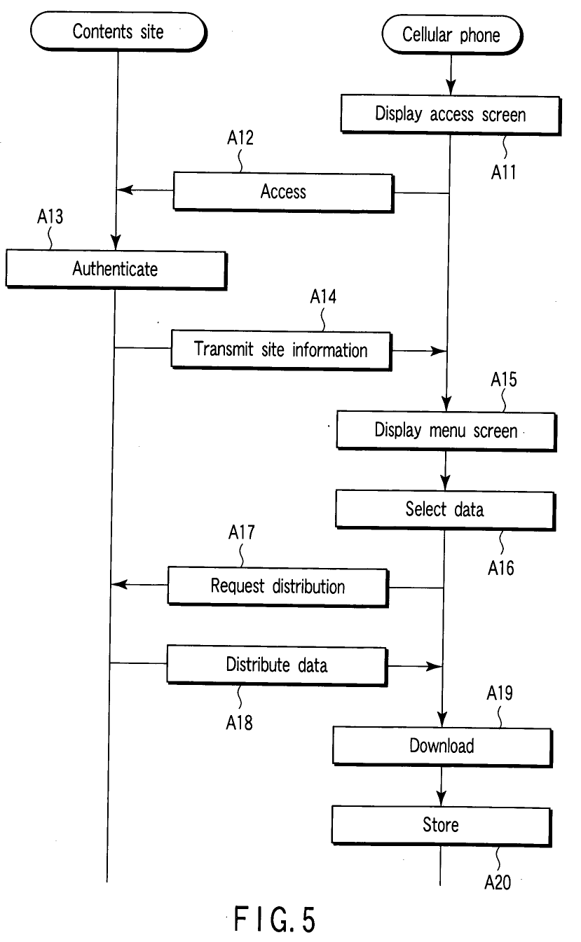

A method of managing contents data that is downloaded into the cellular phone 16 will be described with reference to FIGS. 5 to 8.

FIG. 5 is a sequence chart of a procedure for downloading contents data from the contents site 21 by the cellular phone 16.

First, a user operates the cellular phone 16 to display a given access screen on the display unit 54 (step A11). The user inputs his or her ID and password on the access screen to gain access to the contents site 21 (step A12). A link to the contents site 21 is performed through the base station 19 shown in FIG. 1.

Upon receiving a link request from the cellular phone 16, the contents site 21 authenticates the cellular phone 16 based on the ID and password sent from the cellular phone 16 (step A13). When the contents site 21 authenticates the cellular phone 16, it transmits site information to the cellular phone 16 (step A14). The site information includes the kinds of contents data provided by the contents site 21.

Upon receiving the site information, the cellular phone 16 displays the menu screen 22 shown in FIG. 2 (step A15). The menu screen 22 shows a list of various items of contents data provided by the contents site 21. When the user selects desired data on the menu screen 22 (step A16), a request for distribution of the data is sent to the contents site 21 (step A17).

In response to the request for distribution, the contents site 21 distributes contents data (step A18). The contents data distributed from the contents site 21 is downloaded into the cellular phone 16 (step S19) and stored in the memory 52 of the cellular phone 16 (step A20).

If the contents data downloaded from the contents site 21 is music data or moving picture data for an incoming call, it can be changed and reproduced as a normal ringing melody when an incoming call is made by setting the data in a melody ringing function of the cellular phone 16.

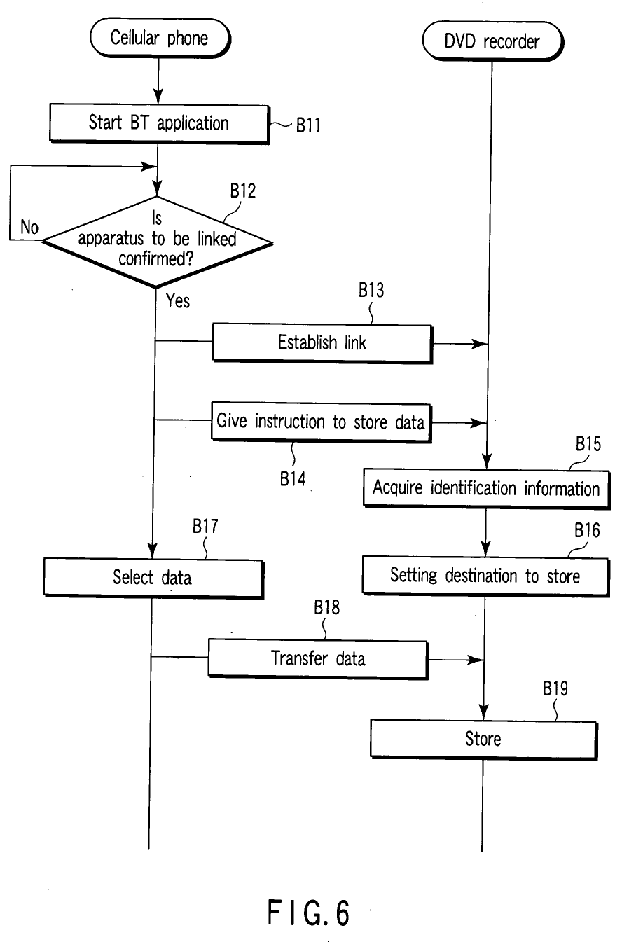

FIG. 6 is a sequence chart of a procedure for transferring the contents data downloaded into the DVD recorder 11 to the cellular phone 16.

First, a user starts a BT application loaded into the cellular phone 16 (step B11). Assume here that if a BT application of the DVD recorder 11 starts and the DVD recorder 11 falls within a given range (e.g., 10 m), radio communication can be performed between them at all times.

The cellular phone 16 sends radio waves 17 in a given frequency band through the BT communication unit 56 to search for an apparatus to be linked thereto (step B12). When the DVD recorder 11 is confirmed as an apparatus to be linked to the cellular phone 16 (Yes in step B12), the cellular phone 16 requests the DVD recorder 11 to be linked thereto under a given communication protocol to establish a radio link between them (step B13). If the cellular phone 16 fails to establish a radio link to the DVD recorder 11 because the DVD recorder 11 is located at a distance from the cellular phone 16, it tries to do the radio link again.

If the radio link is established, the cellular phone 16 instructs the DVD recorder 11 to store data (step B14). If folders have already been set in the DVD recorder 11 in correspondence with their respective terminals, the cellular phone 16 gives an instruction of which holder stores data upon receipt of a command.

If a folder in which data is to be stored is not set in the DVD recorder 11, the DVD recorder 11 acquires identification information of the cellular phone 16 (step B15) and creates a folder dedicated to the cellular phone 16 in the memory 32 based on the identification information (step B16).

A BT (Bluetooth) address is used as the identification information. The BT address is an identifier that is in conformity with the 48-bit IEEE 802 standards and assigned in advance to each of terminals. The BT address is sent from a terminal when a link is established with the terminal.

Then, the cellular phone 16 selects contents data from the memory 32 (step B17) and transfers the selected data to the DVD recorder 11 through the BT communication unit 40 (step B18).

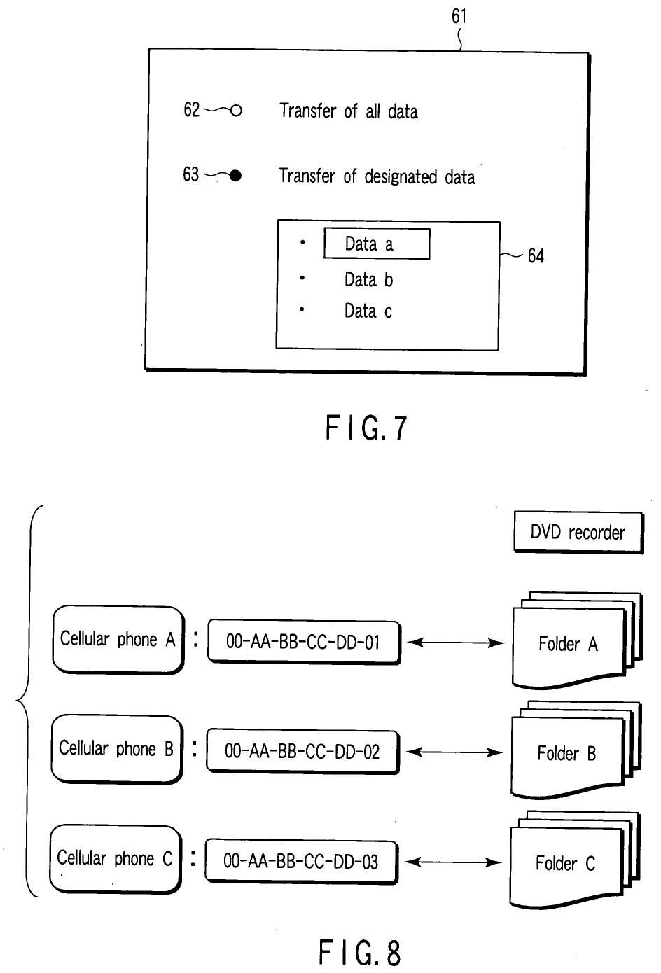

In order to transfer contents data from the cellular phone 16, all the contents data stored in the memory 32 can be transferred or only the contents data designated therein can be transferred. The user sets in advance on a transfer setting screen 61 as to whether all the data is transferred or only the designated data is transferred, as shown in FIG. 7.

The transfer setting screen 61 is provided with radio buttons 62 and 63. When the user selects the radio button 62, all the contents data stored in the memory 32 is transferred. When the user selects the radio button 63, a data list screen 64 is displayed and only the contents data selected from the screen 64 is transferred.

Upon receiving the contents data from the cellular phone 16, the DVD recorder 11 stores it in a given folder corresponding to one of the BT addresses of the cellular phone 16 (step B20). In this embodiment, the folders are created in the memory 32 and data is stored therein. However, the DVD 39 can be started to store data in media such as a DVD.

FIG. 8 is a diagram showing a relationship between BT addresses of cellular phones and folders of the DVD recorder 11. Assume here that radio communication can be carried out between three cellular phones A, B and C and the DVD recorder 11. The DVD recorder 11 includes folders A, B and C corresponding to the cellular phones A, B and C, respectively.

The contents data transferred from the cellular phone A is stored in folder A that is in a one-to-one relationship with the BT address “00-AA-BB-CC-DD-01” of the cellular phone A. Similarly, the contents data transferred from the cellular phone B is stored in folder B corresponding to the BT address “00-AA-BB-CC-DD-02” of the cellular phone B. The contents data transferred from the cellular phone C is stored in folder C corresponding to the BT address “00-AA-BB-CC-DD-03” of the cellular phone C.

When the DVD recorder 11 is shared among a plurality of cellular phones as described above, data of each of the cellular phones is stored and managed based on its corresponding BT address. Consequently, a number of items of data of the cellular phones are not mixed together, or since a BT address is required to take out data, any person other than the user cannot read it freely.

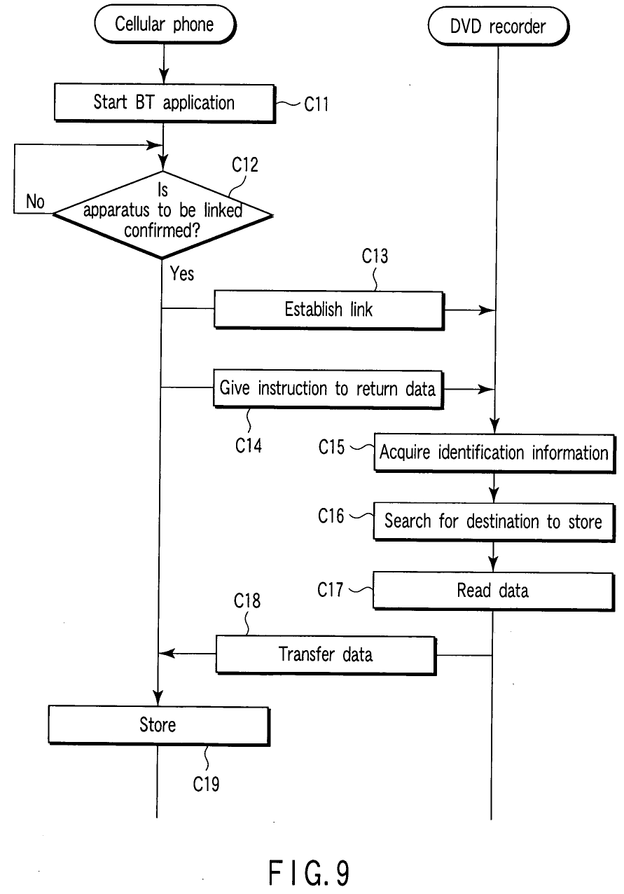

FIG. 9 is a sequence chart of a procedure for returning the contents data from the DVD recorder 11 to the cellular phone 16.

First, a user starts a BT application loaded into the cellular phone 16 (step C11). Assume here that if a BT application of the DVD recorder 11 starts up and the DVD recorder 11 falls within a given range (e.g., 10 m), radio communication can be performed between the cellular phone and the DVD recorder.

The cellular phone 16 sends radio waves 17 in a given frequency band through the BT communication unit 56 to search for an apparatus to be linked thereto (step C12). When the DVD recorder 11 is confirmed as an apparatus to be linked to the cellular phone 16 (Yes in step C12), the cellular phone 16 requests the DVD recorder 11 to be connected thereto under a given communication protocol to establish a radio link between them (step C13). If the cellular phone 16 fails to establish a radio link to the DVD recorder 11 because the DVD recorder 11 is located at a distance from the cellular phone 16, it tries to do the radio link again.

If the radio link is established, the cellular phone 16 instructs the DVD recorder 11 to return data (step C14). Upon receiving the instruction from the cellular phone 16, the DVD recorder 11 acquires a BT address corresponding to the identification information of the cellular phone 16 (step C15). Then, the DVD recorder 11 searches for a data-store destination in which the data of the cellular phone is stored, based on the BT address (step C16). If the cellular phone 16 is the cellular phone A as shown in FIG. 8, the DVD recorder 11 searches for folder A as a data-store destination based on the BT address “00-AA-BB-CC-DD-01” of the cellular phone A.

If the DVD recorder 11 searches for a folder in which data is stored, it reads contents the data therefrom (step C17) and transfers it to the cellular phone 16 through the BT communication unit 40 (step C18). The cellular phone 16 stores the contents data in the memory 52 (step C18).

As described above, the contents data acquired using the cellular phone 16 can be stored in the DVD recorder 11 or the contents data stored in the DVD recorder 11 can be returned to the cellular phone 16 when necessary. Consequently, the data once acquired can be stored safely and used appropriately when the need arises, without deleting the data due to a limitation of the memory capacity of the cellular phone 16.

The state of a link between the cellular phone 16 and the DVD recorder 11 is radio communication. Thus, a user need not perform a complicated operation such as a cable connection, but can achieve data transfer between them without any consciousness. For example, when a user comes home, he or she can automatically transfer data from his or her cellular phone to the DVD recorder, and vice versa.

The DVD recorder 11 can communicate with a number of cellular phones as well as one cellular phone 16 as shown in FIG. 8 and, in this case, it manages data items of the cellular phones individually. Since the data items are managed based on identification information (BT address) proper to the respective cellular phones, any person other than the user can be prevented from reading data freely, thereby retaining security.

In the foregoing embodiment, the cellular phone 16 transfers data to the DVD recorder 11 when they are linked to each other by radio communication. However, the cellular phone 16 can be configured to transfer data when it is set in a charger (cradle), not shown.

More specifically, a charging operation of the cellular phone 16 is sensed by the setting condition of the charger. When the charging operation is sensed, the contents data is read out of the memory 52 and transferred to the DVD recorder 11 through the BT communication unit 56. Thus, a user can transfer the contents data to the DVD recorder 11 while the cellular phone 16 is being charged, without any consciousness.

(Method of Notifying User of Incoming Call in Silent Mode)

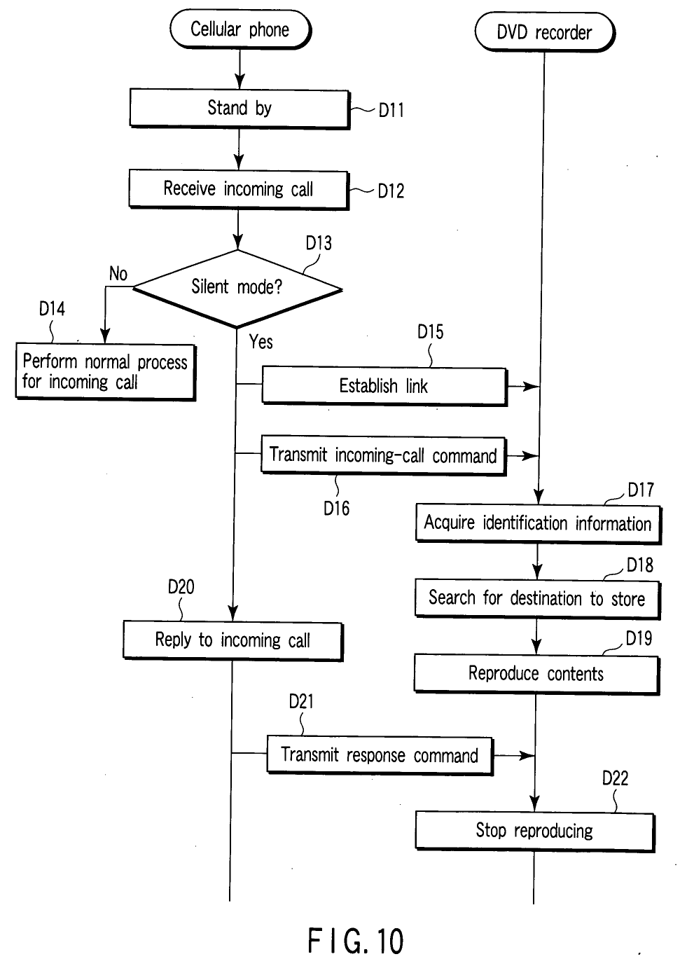

A method of notifying a user of an incoming call when the cellular phone 16 is set in silent mode will be described with reference to FIG. 10. The silent mode is one of the incoming-call functions of the cellular phone 16 and called a “silent incoming-call notification mode”. In this silent mode, the user is notified of an incoming call by silence using a vibrator or the like. The silent mode can freely be set/released by a given operation.

FIG. 10 is a sequence chart of a procedure for notifying a user of an incoming call in silent mode using a playback function of the DVD recorder 11.

Assume here that the cellular phone 16 is on standby near the DVD recorder 11 (step D11). Upon receiving an incoming call (step D12), the cellular phone 16 performs a normal process for the incoming call (step D14) if it is not set in silent mode (No in step D13). In other words, the cellular phone 16 outputs a preset incoming-call sound through a speaker or the like.

On the other hand, if the cellular phone 16 is set in silent mode (Yes in step D13), it requests the DVD recorder 11 to be connected thereto under a given communication protocol to establish a radio link between them (step D15). After that, the cellular phone 16 transmits an incoming-call command to the DVD recorder 11 to notify the DVD recorder 11 of the incoming call (step D16).

Upon receiving the incoming-call command, the DVD recorder 11 acquires a BT address as identification information of the cellular phone 16 (step D17). Based on the identification information, the DVD recorder 11 searches a folder in which data of the cellular phone 16 is stored (step D18). Then, the DVD recorder 11 reads contents data, which is preset for the incoming call, from the folder and outputs it through an audio component (step D19).

If the contents data is music data for the incoming call, it is output from the speaker 13 connected to the DVD recorder 11. If the contents data is moving picture data for the incoming call, it is displayed on the TV monitor 12 connected to the DVD recorder 11.

When the user notices the incoming call and responds thereto by, e.g., depressing an incoming-call button of the cellular phone 16 (step D20), the cellular phone 16 transmits a response command to the DVD recorder 11 (step D21). The response command means the end of the incoming-call operation. The DVD recorder 11 therefore completes a playback operation upon receipt of the response command (step D22).

When the cellular phone 16 is set in silent mode, the user is notified of an incoming call through the DVD recorder 11. Even though the cellular phone 16 is put in a bag or a desk while it is set in silent mode, the user can notice and respond to an incoming call at once.

(Data Edit Function of DVD Recorder)

A data edit function of the DVD recorder 11 will be described.

The DVD recorder 11 can reproduce music data and moving picture data even alone irrespective of whether it receives an incoming call from the cellular phone 16. The DVD recorder 11 has a function of editing the data in accordance with the model of the cellular phone.

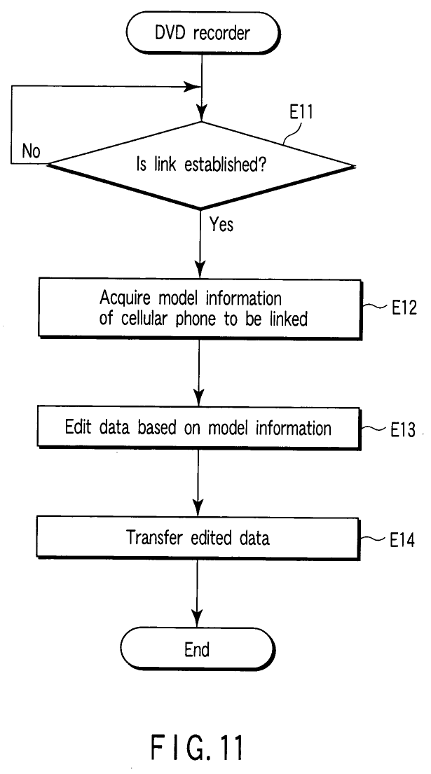

FIG. 11 is a flowchart showing a procedure for editing data in the DVD recorder 11. Assume here that the memory 32 of the DVD recorder 11 stores the contents data to be transferred. The contents data can be transferred from the cellular phone 16 or a device (e.g., a digital movie camera) other than the cellular phone 16.

As the user's cellular phone 16 gets close to the DVD recorder 11, a radio link is established between them under a given communication protocol (step E11). Then, the DVD recorder 11 acquires model information as well as a BT address from the cellular phone 16 to determine the model of the cellular phone 16 (step E12).

The DVD recorder 11 reads the contents data from the memory 32 and edits it in accordance with the model of the cellular phone 16 (step E13).

More specifically, if the contents data is music data and the DVD recorder 11 is linked to a cellular phone, the music data is edited short as a ringing melody in consideration of the memory capacity of the cellular phone. Since there is a cellular phone that can produce ringing melody only in a monotone, the music data has to be edited in consideration of a difference in reproduction performance.

After that, the DVD recorder 11 transfers the edited contents data to the cellular phone 16 through the BT communication unit 40 (step E14).

As described above, the DVD recorder 11 edits contents data in accordance with the model of the cellular phone 16 and transfers the edited contents data. In the cellular phone 16, therefore, the contents data transferred from the DVD recorder 11 can be used for an incoming-call sound as it is.

According to the above embodiment of the present invention, data of a portable terminal with a small memory capacity can be transferred without any troublesome linking operation, and the transferred data can be stored and managed in correspondence with the portable terminal. Consequently, data once acquired can be stored safely and used appropriately when the need arises, without deleting the data due to a limitation of the memory capacity of the portable terminal.

The foregoing embodiment is directed to a DVD recorder as a data processing apparatus. The present invention can be applied to any electronic device if the device has a recording/reproduction function. The portable terminal communicating with the data processing apparatus is not limited to a cellular phone. For example, a personal digital assistant (PDA) and a portable digital audio player can be used. The present invention is not limited particularly to any model of a portable terminal if the portable terminal can transfer its data to another apparatus having a large memory capacity by radio communication.

The contents data that can be acquired from outside by a portable terminal includes programs such as game applications as well as music data and moving picture data. Since the amount of data of the programs is large, the programs are transferred to the data processing apparatus and stored therein, with the result that the memory of the portable terminal can be used effectively.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data processing apparatus comprising:
a link unit which links to a portable terminal by radio communication within a given range;
an identification information acquisition unit which acquires identification information proper to the portable terminal linked by the link unit;
a data-store destination setting unit which sets a data-store destination corresponding to the portable terminal, based on the identification information acquired by the identification information acquisition unit; and
a holding unit which holds data transferred from the portable terminal in the data-store destination set by the data-store destination setting unit.

2. The data processing apparatus according to claim 1, further comprising:
a search unit which searches the data-store destination corresponding to the portable terminal, based on the identification information upon receipt of an instruction to return data from the portable terminal; and
a return unit which reads data from the data-store destination searched by the search unit and returning the data to the portable terminal.

3. The data processing apparatus according to claim 1, further comprising:
a storage unit which stores data;
a model information acquisition unit which acquires model information of the portable terminal;
an edit unit which edits the data stored in the storage unit, based on the model information acquired by the model information acquisition unit; and
a transfer unit which transfers the data edited by the edit unit to the portable terminal.

4. A data processing apparatus comprising:
a link unit which links to a portable terminal by radio communication within a given range;
an identification information acquisition unit which acquires identification information proper to the portable terminal linked by the link unit;
a data-store destination setting unit which sets a data-store destination corresponding to the portable terminal, based on the identification information acquired by the identification information acquisition unit;
a holding unit which holds data transferred from the portable terminal in the data-store destination set by the data-store destination setting unit;
an operation sensing unit which senses a specific operation of the portable terminal; and
a processing unit which performs a process related to the specific operation using the data held by the holding unit when the operation sensing unit senses the specific operation of the portable terminal.

5. The data processing apparatus according to claim 4, wherein the operation sensing unit senses an incoming-call operation of the portable terminal that is set in a silent incoming-call notification mode.

6. The data processing apparatus according to claim 4, wherein the processing unit includes:
a search unit which searches the data-store destination corresponding to the portable terminal based on the identification information; and
a reproduction unit which reproduces data from the data-store destination searched by the search unit.

7. The data processing apparatus according to claim 6, wherein the processing unit includes a reproduction stop unit which stops a data reproduction operation performed by the reproduction unit, when the specific operation of the portable terminal ends.

8. The data processing apparatus according to claim 1, wherein the portable terminal includes:
an access unit which accesses a site on a network;
a storage unit which stores data that is downloaded from the site accessed by the access unit;
a transfer unit which transfers the data stored in the storage unit by radio communication; and
a data-store destination indication unit which indicates a data-store destination for data that is transferred by the transfer unit.

9. The data processing apparatus according to claim 8, wherein the transfer unit transfers data while the portable terminal is being charged.

10. A method of processing data in a data processing apparatus having a radio communication function, comprising:
linking the data processing apparatus to a portable terminal by radio communication within a given range;
acquiring identification information proper to the portable terminal;
setting a data-store destination corresponding to the portable terminal, based on the identification information; and
holding data transferred from the portable terminal in the set data-store destination.

11. A method of processing data in a data processing apparatus having a radio communication function, comprising:
linking the data processing apparatus to a portable terminal by radio communication within a given range;
acquiring identification information proper to the portable terminal;
setting a data-store destination corresponding to the portable terminal, based on the identification information;
holding data transferred from the portable terminal in the set data-store destination;
sensing a specific operation of the portable terminal; and
performing a process related to the specific operation using the data held in the data-store destination when the specific operation of the portable terminal is sensed.
